(19) United States
(12) Patent Application Publication
(10) Pub. No.: US 2017/0076620 A1
(43) Pub. Date: Mar. 16, 2017

(54) SYSTEM AND METHOD FOR DEFINING CLASS MATERIAL BASED ON STUDENTS PROFILES

(71) Applicant: SAMSUNG ELECTRÔNICA DA AMAZÔNIA LTDA., Campinas (BR)

(72) Inventors: Tiago THOMPSEN PRIMO, Campinas (BR); Fernando Koch, Florianópolis (BR); Orlando Volpato, Santo Antonio de Posse (BR)

(73) Assignee: SAMSUNG ELECTRÔNICA DA AMAZÔNIA LTDA., Campinas (BR)

(21) Appl. No.: 15/167,310

(22) Filed: May 27, 2016

(30) Foreign Application Priority Data
Sep. 10, 2015 (BR) 102015022438-9

(51) Int. Cl. G09B 5/12; G09B 7/00

(52) U.S. Cl. CPC G09B 5/12; G09B 7/00

(57) ABSTRACT

A system and method for defining class material based on students profiles including: adding learning objects by the user through input/output interface to a class builder module, in an iterative process; automatically or manually generating the group of students by the user; processing the learning object recommendations considering a recommendation system algorithm, machine learning, rules-based system or any algorithm of artificial intelligence; removing the recommendations if the user does not accept the recommendations; requesting the generation of more recommendations by the user, in an iterative process; creating a class package; and storing the class package in the class compositions repository in domain dependent databases.

### FIELD OF THE INVENTION

The present invention refers to a method applied in the educational context to help educators during the composition of digital education material considering multi-dimensional contextual aspects, the learning context C, which involves pedagogical characteristics, student behavior, historical performance, student and group profile, material profile, and others. The method disclosed in the present invention allows to: (i) generate recommendations of complement material R(M) that adds value to material M considering the demands DEM(C) inferred from learning context C; and (ii) to automatically compose a set of digital material M based on repository of learning objects R and demands DEM(C) inferred from learning context C and (iii) store the base and personalized compositions for reuse.

### BACKGROUND OF THE INVENTION

Educators have been facing challenging situations regarding the time spent to compose a class and the quality of the educational materials for digital education scenarios. The students are eager to more dynamic and challenging classes, but many of the educators do not have the necessary time to search for different and personalized educational contents that support their classes.

In addition, students have different learning paces, in which computer-aided personalized complementary materials could help them to keep up with the rest of the class improving the overall evaluation. The educator would benefit from this solution considering that it proposes the automatic identification of students' difficulties and further recommend complementary material to cope with this deficiency.

The usage of such technology is an alternative to stimulate students' engagement and to cope with the differences between the learning paces of the students. For instance, in a classroom, some students need complementary materials to keep up and other ones need complementary materials to be stimulated.

Although it is still a taboo, the myth that mobile devices in classroom are prejudicial to learning, and might cause distractions, show a large trend to fall in some schools. Since the emergence of pedagogical methodologies such as Flipped Classroom, were the role of the students is contributing with educational materials and discussion topics, or the BYOD (Bring Your Own Device) initiative, the role of the educators is to guide the students trough the learning process. This scenario is fertile for the usage of educational technology in classroom.

Flipped Classroom is not a reality in a majority of schools, where the educators are the central element of the class. Innovations, such as the proposed in the present invention, cope with those educators where current solutions of technology-enhanced learning fail to support them in class composition situations.

According to the scope of the present invention, the composition of a class copes with situations where the educator needs to organize a set of educational contents for a set of students considering one class at a time. Such educational contents must be compatible, or referenced, by digital educational applications.

Current Solutions such as LOMPAD, SCAM, eXe Learning and LOIT, copes with the editing process of educational materials. Those tools allow the metadata description, and export the resulting file to XML, SCORM among others. The difference from those initiatives to the present invention relates to the proposal of a system that will add to the composition workflow a recommendation engine to complement classroom materials and to provide an automatic interface that will cope with a technology enhanced learning platform. For further and detailed information about these existing solutions, see the following references:
Palmèr, M., Naeve, A., and Paulsson, F. (2004). The scam framework: helping semantic web applications to store and access metadata. In The Semantic Web: Research and Applications, pages 167-181. Springer;
LOMPAD, Retrieved Mar., 19 2014 from http://helios.licef.ca:8080/lompad/en/index.htm;
LOMEditor. Retrieved Mar., 19 2014 from http://dbis.rwthaachen.de/cms/projects/lomeditor;
eXeLearning. Retrieved Mar., 19 2014 from http://exelearning.org/;
Ghebghouba, O., Abelb, M.-H., Moulinb, C., and Benmmohamedc, M. (2009). Loit: An indexing tool based on lom ontology

The method of the present invention is intended to be applied in digital educational scenarios. The main difference from the present invention relates to the fact that its features/capabilities are extended, providing an alternative to cope with educators in class composition situations providing the personalization of Learning Objects according to students' characteristics and pedagogical aspects.

Patent document US 2013/0266922 A1 titled “Recommending Competitive Learning Objects”, published on Oct. 10, 2013, by Apollo Group, Inc., proposes a method and apparatus that analyses the performance of a student with a Learning Object (LO), and based on this feedback the system recommends this learning object to another student with educational difficulties, Document US 2013/0266922 A1 encompass, among other, a knowledge base, a learning content manager and a data analysis engine. Such components are used to cope with students cognitive aspects and the aspects related to the learning object to provide the recommendation interface. The difference from the present invention is that it considers, firstly, the contents that were pre-select by an educator to compose a class, and it recommends complementary material based on the students profiles.

Patent document US 2009/0035733 A1 titled “Device, System, and Method of Adaptive Teaching and Learning”, published on Feb. 5, 2009, by Meitar, S. Weiss, D. and Gal, M., describes a class management module for teaching/learning systems that will monitor the students' knowledge levels in a plurality of topics in order to allocate an activity to a student considering their characteristics. The difference of the present invention is that it proposes the suggestion of educational contents considering that a class will have specific sets of students and considers only aspects regarding assessment performance.

Patent document US 2012/0288841 A1 tiled “Methods and Systems for Clustering Students Based on Their Performance”, published on Nov. 15, 2012, by Xerox Corporation, describes a method to group students accord to their characteristics, wherein the similarity of the students is made through assessment tasks. The performance during a task is analyzed and the ones with similar scores are considered a part of the same group. The difference from the present invention relates to the fact that the current invention is open to the definition of the groups of students. Beyond this invention, we could use meta-information to create the groups of users.

U.S. Pat. No. 8,457,544 B2 titled “System and Method for Recommending Educational Resources”, published on Jul. 4, 2013, by Xerox Corporation and Palo Alto Research Center Incorporate, describes a recommender system that will cluster students by at least one characteristic from one of them by approximating an educational resource with this group of students to make a recommendation. The difference of the present invention is related to the fact that beyond the recommendation of a complementary material to a set of students, this recommendation generates an educational package that can be reused by different educators.

Patent document US 2005/0287509 A1 titled “Learning Objects in an Electronic Teaching System”, published on Dec. 29, 2005, by Mohler, Sherman discloses a system that allows learning objects to be delivered among different educational applications through a network, and a method to extract the meta-information from one learning object and to present at an interface to the student. Although document US 2005/0287509 A1 is intended to deliver personalized contents, the presented personalization refers to the different platforms in which the learning object will be present. The difference from this invention is on the presentation of a mechanism to identify the student's profiles and automatically recommend personalized learning objects.

### SUMMARY OF THE INVENTION

The invention presents a system and method to recommend complementary educational materials for a core class composition of learning objects considering that a classroom has a database of learning objects and different students' profiles, with different characteristics. The recommendations are regarding complementary learning objects considering data from students, educators, learning objects, sensor collected data and pedagogical methodologies. For the scope of the present invention, learning objects are any resource used for educational purposes with a metadata file associated.

The recommendations are performed considering the individual characteristics of the students and inferred parameters about the learning context, such as pedagogical characteristics, student behavior, historical performance, student and group profile, material profile, and others. The suggestions are realized considering a list of ordered learning objects, complementing this list by adding learning objects at any position of this list. The suggested learning objects are intent to contextualize, complement, and build a mental association or to reinforce the learning.

The recommendations are complementary to a set of learning objects. Every composition is stored for further use. For instance, if there are five fourth grade classes, it will have a core composition for them and up to five distinct personalized compositions that are built considering the students profiles. Those compositions are stored and can be shared with other educators. The system according to a preferred embodiment of the present invention is designed to continuously produce automatic content suggestions, only based on students/class characteristics (both behavioral and learning tests/evaluation), and then leave those content packages, suggestions available to the educators to use or customize. The solution is mainly directed to digital educational platforms, providing the recommendation of complementary materials from a core set of learning objects. Along with that, the method of the present invention copes with a metadata representation that allows the storage and indexing of the learning objects compositions for further reuse and interoperability among digital educational platforms.

An embodiment of the present invention is composed by a software tool to assist at the composing of a set of educational materials, along with personalized complementary learning objects. The present invention's operation works as follows: (i) the educator will log in to a system that will allow the composition of educational materials for a class; (ii) the educator can search and add educational contents, or, retrieve a previous class composition; (iii) the system analyzes the added educational materials, the students profiles and pedagogical aspects, and then suggest complementary educational contents based on the students profile; finally, (iv) the system generates a file with metadata associated to provide reuse among digital educational applications. This file stores data regarding the basic composition and the personalized items that were incorporated.

The objectives and advantages mentioned above are achieved by a method for defining class material based students profiles, comprising the steps of:

adding learning objects by the user through input/output interface to a class builder module, in an iterative process;

automatically or manually generating the group of students by the user;

processing the learning object recommendations considering a recommendation system algorithm, machine learning, rules-based system or any algorithm of artificial intelligence;

removing the recommendations if the user does not accept the recommendations;

requesting the generation of more recommendations by the user, in an iterative process;

creating a class package; and

storing the class package in the class compositions repository in domain dependent databases.

Further, the objectives and advantages mentioned above are also achieved by a system for defining class material based on students profiles, comprising:

an input/output interface, which defines the specific parameters for the input information and the knowledge output/generation;

domain dependent databases;

pedagogical plan module, defining the pedagogical characteristics to be developed in a course;

class builder module, which gather the set of learning objects selected by the educator to a specific topic and a set of students, and process these learning objects to derive knowledge and generate personalized recommendations.

The present invention provides a clear competitive advantage in the scope of digital educational applications where the solution introduces an innovative and differentiated method to cope with automatic personalization and composition of classes. The present invention further extends existing solutions by recommending educational materials to help the educator on class compositions since it: (i) provides an interface that performs the suggestion of complementary materials (ii) provides an interface that will pack a set of educational contents in an interoperable format (iii) generates the final digital class format considering the contents that were chosen by the educator, and (iv) provides an interface to store those packed educational contents for further reuse.

### BRIEF DESCRIPTION OF DRAWINGS

The objectives and advantages of the present invention will become more clear by means of the following detailed description of a preferred but non-limitative embodiment of the invention, in view of its appended figures, wherein:

FIG. 1 shows an overview of the system (102) according to an embodiment of the present invention;

FIG. 2 shows an example of the complementary learning objects, as a resulting recommendation of the system (102)

FIG. 3 shows a workflow of the method (200) according to an embodiment of the present invention, implemented by the system (102).

### DETAILED DESCRIPTION OF THE INVENTION

The present invention deals with educational applications based on digital education scenarios, dealing with class composition activities. Such activities are intent to be performed by educators (teachers, tutors and independent professionals), helping them to reduce time and effort usually expend by searching, composing and organizing the materials for a class.

The method according to an embodiment of the present invention is applied in the context of digital educational applications to assist educators in class composition activities considering different students pedagogical characteristics. Thus, the present invention allows (i) to manually composing a class with or without any personalization feature, (ii) to generate recommendations of complementary materials according to students and contextual characteristics and (iii) to automatically generate an interoperable format of a class.

According to the scope of the present invention, the composition of a class copes with situations where the educator needs to reuse and/or organize a set of educational contents for a of students. Such educational contents must be compatible, or referenced, by digital educational applications.

The present invention further extends existing solutions by recommending educational materials to help the educator on class compositions since it: (i) provides an interface that performs the suggestion of complementary material (ii) provides an interface that packs a set of educational contents in an interoperable format (iii) generates the final digital class format considering the contents that were chosen by the educator, and (iv) provides an interface to store those packed educational contents for further reuse.

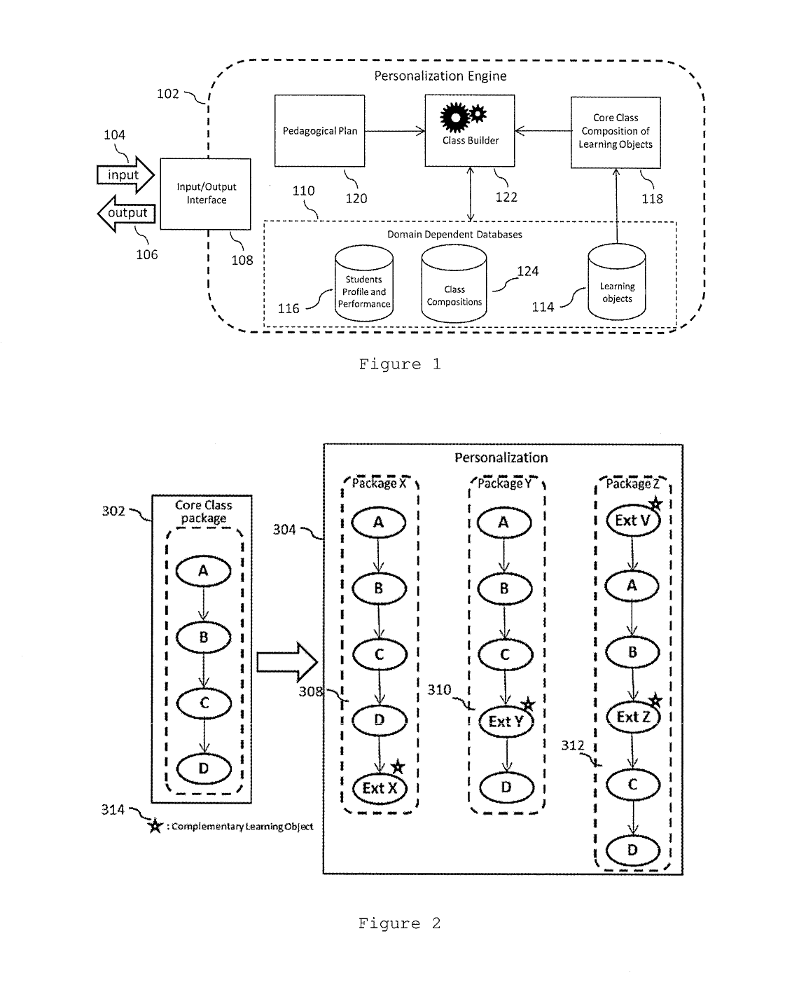

In order to accomplish the above mentioned objectives and advantages, an overview of the system according to an embodiment of the present invention is shown in FIG. 1, the system (102) from now on being called “Personalization Engine”. The system (102) has an input/output interface (108). This interface (103) can be implemented by service architectures, defining the specific parameters for the input (104) of information and output (106) of knowledge.

The system (102) is composed by domain dependent databases (110). Those databases (110) are fundamental to the whole invention, since they are composed by the students profile and performance (116), class compositions (118), learning objects (114) and class social characteristics (112),

The class social characteristics (112) encompass the behavioral aspects of the students, their proximity and interaction with another students, voice pitch, and, if instrumented, the facial expressions during the class. An example can be the student's emotional inference based on captured facial expressions.

The learning objects (114) database is composed by a repository infrastructure with an internet interface that allows the search, retrieve and storage of learning objects, Those learning objects are educational materials with well-defined metadata standards. For instance, an example could be a PDF file about trigonometry, with an associated OWL file describing its contents with the LOM metadata vocabulary.

The students profile and performance (116) database is a repository that stores, retrieves and updates the educational experiences of the students in a digital learning environment. This database (116) stores, for instance, the unique user identification, the activities (posts, forum participations, chats, among many others) performed in digital learning environments, the interactions with other students and educators, the performance in educational tasks, received and accessed recommendations, physiological aspects among others. For storage purposes, the data and information stored are compliant with a metadata standard, for instance, an OWL file based on FOAF (Friend of a friend) standard ontology.

The class compositions (118) database stores every composition made by the educators and its personalized variations. Every composition comprises a set of learning objects, and, a metadata description. Such compositions also store the metadata information regarding the subject, pedagogical style and the competence to be developed. An example could be a composition of World War 1 describing the time period with Videos, Images and Textual information. A class composition could be described with an OWL file along with a set of properties that reflects an educational metadata standard.

The Core Class Composition of Learning Objects (118) represents the learning objects that were selected, or a composition imported, by the educator for a specific topic and set of students. Usually it is related to a discipline and a learning period. For instance, the first lecture of Math for third grade students after the summer vacation.

The pedagogical plan (120) represents the pedagogical characteristics to be developed in a course. For instance, for the second grade students of math, they have to learn subtraction, and, after a test that evaluates their performance, learn multiplication. For instance, this could be used to enforce official education standards—as the US “Common Core State Standards”—; the system, indeed, could use the “pedagogical plan” to verify the covered items, once the learning objects set is packaged.

The class builder (122) is the last step for the personalization engine. The role of class builder (122) is to gather those informations and process them to derive knowledge and generate personalized recommendations. Its operation can be made through logical inference, rule-based systems, machine learning or any other variation of artificial intelligence algorithms that copes with knowledge representations,

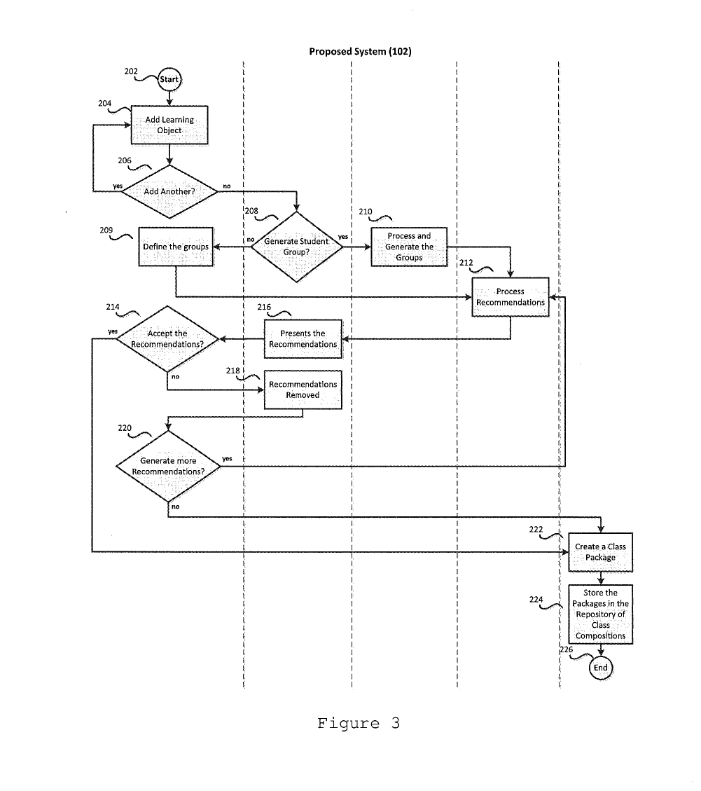

The class builder (122) is the system module/component which stands for the method of the present invention that will be further described in FIG. 3. This module/component (122) is able to: (i) generate student groups according to pedagogical and student's characteristics; (ii) recommend learning objects to support class composition and personalization; (iii) create and store the class packages in a standardized matter.

An implementation of the class builder (122) could be realized with the usage of an ontology reasoner. To accomplish that, it is supposed that: (i) a higher level ontology is necessary to provide the properties to describe the learning objects, learning objects will be described as ontology individuals (instances) of the higher level ontologies, (iii) to reason, we import the higher level ontologies and the learning object individuals into a single ontology, (iv) after this process an Axiom associated with an ontology class is described, this axiom will be used by the ontology reasoner in order to identify which learning object individuals match the defined axiom, finally the learning objects that match the described axiom are inferred as instances of the class.

A sample usage scenario consists of 100 learning objects retrieved from the MIT learning repository. Those learning objects are mapped to the proposed ontology reasoning mechanism as ontology individuals. Reasoning over this information, we import those 100 learning objects to an ontology and describe an axiom that analyses the presence of an accessibility property regarding visual imparity. Among the set of 100 learning objects, the ontology reasoner will automatically infer the ones that cope with the described axiom. The system (102) generates results like presented in FIG. 2. The educator will provide a core class package (302). Figures, text, videos, quizzes or any other learning objects can compose this package (302). This core class package (302) will be analyzed by the proposed system (102) in order to verify its consistency and compatibility with the pedagogical characteristics of the students in a class.

The result of this process is a set (304) of educational class packages (308, 310, 312) considering distinct students profiles and providing complementary learning objects (314) that are intended to support the students learning process. Such class packages (308, 310, 312) are complemented by N recommendations of learning objects for a specific class and considering the variables mentioned previously that are encompassed by the system (102).

Such recommendations are independent of position, which means that it provides alternatives to recommend a learning object that could complement a whole class, such as package X (308), it can be made a recommendation in the middle of the composition, like package Y (310), or even, to recommend a set of learning objects in different positions of the composition such as package Z (312).

One of the scenarios that the present invention encompasses can be observed within the workflow presented in FIG. 3. The method (200) of the embodiment of the present invention starts (202) when the user add learning object (204) to a class composition. Adding learning objects (204) is an iterative process wherein the user can add (206) as much learning objects as necessary to comply with the educational practice.

Once the adding process is finished, the method, through a computer interface, asks for the user to generate student group (208). This generation can be made automatically through the method (200) implemented by the system (102), or manually by the user. When automatic generated, the process and generation of the groups (210) are made considering the students profile similarities or complementary cognitive aspects. When manually generated, the user determines and selects the number and participants for each group (209).

Regardless if the user group is generated automatically (210) or manually (209), the method (200) implemented by the system (102) processes the recommendations (212) of learning objects considering a recommender system algorithm, machine learning, rule-based system or any artificial intelligence algorithm. Those recommendations of learning objects are only added to the class composition if the user accept the recommendations (214), otherwise, the recommendations are removed (218),

However, the user can always request to generate more recommendations (220), in an iterative process, where it is considered only the removal of the last generated set of recommendations. Once this process is finished, the method (200) implemented by the system (102) will create a class package (222) and store the packages in the repository of class compositions (224), and the method (200) ends (226).

An example of a real case scenario involves an educator that is overwhelmed by the number of classes that he/she has to teach and do not have time to search for educational materials that are complementary to the different profiles of the students, which are divided in the ones who understand the topic and the ones that are behind in the learning curve. The present invention identifies and processes the student's information seeking for educational deficiencies and providing personalized suggestions of learning objects to complement his/her classes.

Although the present invention has been described in connection with certain preferred embodiment, it should be understood that it is not intended to limit the invention to those particular embodiment. Rather, it is intended to cover all alternatives, modifications and equivalents possible within the spirit and scope of the invention as defined by the appended claims.

1. System (102) for defining class material based on students profiles, characterized in that it comprises:
an input/output interface (108), which defines the specific parameters for the input (104) of information and output/generation (106) of knowledge;
domain dependent databases (110);
pedagogical plan module (120), defining the pedagogical characteristics to be developed in a course;
class builder module (122), which gather the set of learning objects (LO) selected by the educator for a specific topic and set of students, and processes these learning objects to derive knowledge and generate personalized recommendations.

2. System (102) according to claim 1, characterized in that the domain-dependent databases (110) are composed by the profile and performance of students database (116), class compositions database (118), learning object database (114) and database of social class characteristics (112).

3. System (102) according to claim 2, characterized in that the learning object database (114) comprises a repository infrastructure with an internet interface.

4. System (102) according to claim 2, characterized in that the profile and performance of students database (116) is a repository supporting a standard metadata that stores, retrieves and updates the educational experiences of students in a digital learning environment, including: unique identification of the user, the activities carried out in digital learning environments, interactions with other students and educators, the performance in educational tasks, received and accessed recommendations and physiological aspects.

5. System (102) according to claim 2, characterized in that the class compositions database (118) stores all of the compositions made by the educator, and comprises a set of learning objects and a description of metadata about the subject, pedagogical style and competence to be developed.

6. System (102) according to claim 1, characterized in that the class builder (122) is performed by logic inference rule-based systems, machine learning or any other variation artificial intelligence algorithms that deals with knowledge representations.

7. System (102) according to claim 1, characterized in that the inlet (104) to generate processed result/output (106) a set (304) of educational class packets (308, 310, 312) with recommended complementary learning objects (314).

8. A method (200) for defining class material based on students profiles characterized in that it comprises the steps of:
adding learning objects (204) by the user through input/output interface (108) to a class builder module, in an iterative process;
automatically or manually generating the group of students (208) by the user;
processing the learning object recommendations (212) considering a recommendation system algorithm, machine learning, rules-based system or any algorithm of artificial intelligence;
removing (218) the recommendations if the user does not accept the recommendations (214);
requesting the generation of more recommendations (220) by the user, in an iterative process;
creating a class package (222); and
storing the class package in the class compositions repository (224) in domain dependent databases (110).

9. Method (200) according to claim 8, characterized in that the step of generating the group of students (208), when automatically done, the process and the generation of groups (210) considers similarities on students profile or complementary cognitive aspects.

10. Method (200) according to claim 8, characterized in that the step of generating the group of students (208), when manually done, the user determines and sets the number of participants for each group (209).
